(19) United States
(12) Patent Application Publication
(10) Pub. No.: US 2026/0030271 A1
(43) Pub. Date: Jan. 29, 2026

(54) DATA PROCESSING SYSTEM AND DATA PROCESSING METHOD

(71) Applicant: Semiconductor Energy Laboratory Co., Ltd., Atsugi-shi (JP)

(72) Inventors: Junpei MOMO, Sagamihara (JP); Hiroki HOSOSHIMA, Atsugi (JP)

(21) Appl. No.: 19/259,329

(22) Filed: Jul. 3, 2025

(30) Foreign Application Priority Data
Jul. 25, 2024 (JP) 2024-119413

(51) Int. Cl. G06F 16/3329

(52) U.S. Cl. CPC G06F 16/3329; G06F 2216/11

(57) ABSTRACT

A data processing system including three components is provided. A first component receives a scope of claims, a notice of reasons for refusal, an argument draft, and a forecast. A second component receives a prompt, receives and transmits the forecast to a third component, and performs processing using a large language model. The third component receives the scope of claims, the notice of reasons for refusal, and the argument draft, and shares them. The third component including two subcomponents receives and transmits the forecast to the first component. A first subcomponent performs processing using a database including an examination record and a search engine. The search engine extracts an examination record list in accordance with a query. The system has a function of creating a forecast of an examination result and an argument draft in view of the scope of claims, an examiner, a technical field, and the like.

### BACKGROUND OF THE INVENTION

### 1. Field of the Invention

One embodiment of the present invention relates to a data processing system, a data processing method, or a semiconductor device.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Thus, more specifically, examples of the technical field of one embodiment of the present invention disclosed in this specification include a data processing device, a semiconductor device, a memory device, a driving method thereof, and a manufacturing method thereof.

### 2. Description of the Related Art

In recent years, language models using neural networks have been actively developed, and especially large language models (LLM) have attracted attention. A LLM is a natural language processing model learned using a large amount of data. With a large language model, for example, an interactive model that gives an answer to a user's instruction can be achieved. In Non-Patent Document 1, generative pre-trained transformer 4 (GPT-4, registered trademark) is disclosed as a LLM, and ChatGPT is disclosed as an interactive model.

By utilizing a large language model, the capability of a natural language processing model has been significantly increased. On the other hand, owing to the expansion of the language model, it is difficult to incorporate and operate a language model on one's own from the aspect of facilities and costs. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

An object of one embodiment of the present invention is to provide a novel data processing system that is highly convenient, useful, or reliable. Another object is to provide a novel data processing method that is highly convenient, useful, or reliable. Another object is to provide a novel data processing system, a novel data processing method, or a novel semiconductor device.

Note that the description of these objects does not preclude the existence of other objects. One embodiment of the present invention does not need to achieve all these objects. Other objects will be apparent from and can be derived from the description of the specification, the drawings, the claims, and the like.

(1) One embodiment of the present invention is a data processing system including a first component, a second component, and a third component.

The first component has a function of receiving a scope of claims, a notice of reasons for refusal relating to the scope of claims, and a first argument draft relating to the notice of reasons for refusal and transmitting the scope of claims, the notice of reasons for refusal, and the first argument draft to the third component. The first component further has a function of receiving a forecast and providing the forecast.

The second component has a function of receiving a first prompt and transmitting the forecast to the third component. The second component further has a function of performing processing with a large language model. The large language model has a function of generating the forecast in accordance with the first prompt.

The third component has a function of receiving the scope of claims, the notice of reasons for refusal, and the first argument draft and sharing the scope of claims, the notice of reasons for refusal, and the first argument draft in the third component. The third component further has a function of receiving the forecast and transmitting the forecast to the first component. The third component includes a first subcomponent and a second subcomponent.

The first subcomponent has a function of performing processing with a database and a search engine.

The database includes at least one examination record, and the examination record includes a field for storing an argument record, a field for storing a notification record, a field for storing first information specifying an examiner in charge, and a field for storing second information specifying a technical field. Note that the notification record includes a decision on the argument record.

The search engine has a function of extracting a first examination record list from the database in accordance with a first query. The first query requires that the technical field match the scope of claims and requires that the examiner match a person in charge of the notice of reasons for refusal.

The second subcomponent has a function of creating the first prompt and transmitting the first prompt to the second component.

The first prompt includes a first instruction, the first examination record list, and the first argument draft. The first instruction includes a procedure for generating the forecast with reference to the first examination record list. The forecast includes a decision on the first argument draft.

Accordingly, the decision on the first argument draft by the examiner in charge of the notice of reasons for refusal can be forecasted. Furthermore, the decision can be forecasted with reference to the first examination record list relating to the examiner in charge of the notice of reasons for refusal. Furthermore, the decision can be forecasted from the argument record and the notification record stored in the first examination record list. For example, a user of the data processing system can reconsider the first argument draft with reference to the forecast. Furthermore, for example, the user of the data processing system can review a response policy with reference to the forecast. As a result, a novel data processing system that is highly convenient, useful, or reliable can be provided.

(2) Another embodiment of the present invention is the data processing system in which the first component has a function of receiving a response policy and transmitting the response policy to the third component and further has a function of receiving a second argument draft and providing the second argument draft.

The second component has a function of receiving a second prompt and transmitting the second argument draft to the third component. Furthermore, the second component has a function of performing processing with a large language model. The large language model has a function of generating the second argument draft in accordance with the second prompt.

The third component has a function of receiving the response policy and sharing the response policy in the third component. The third component further has a function of receiving the second argument draft and transmitting the second argument draft to the first component.

The search engine has a function of extracting a second examination record list from the database in accordance with a second query. The second query requires that the technical field match the scope of claims, requires that the examiner match the person in charge of the notice of reasons for refusal, and requires that the argument record be equivalent to the response policy.

The second subcomponent has a function of creating the second prompt and transmitting the second prompt to the second component.

The second prompt includes a second instruction and a second examination record list. The second instruction includes a procedure for generating the second argument draft with reference to the second examination record list.

Accordingly, the second argument draft can be generated on the basis of the response policy. For example, it is possible to generate such a second argument draft that the decision on the first argument draft is overturned. Furthermore, for example, it is possible to generate such a second argument draft as to be likely to be accepted by the examiner in charge of the notice of reasons for refusal. As a result, a novel data processing system that is highly convenient, useful, or reliable can be provided.

(3) Another embodiment of the present invention is the data processing system in which the first component has a function of receiving a specification relating to the scope of claims and a reference cited in the notice of reasons for refusal and transmitting the specification and the cited reference to the third component and further has a function of receiving a response policy list and providing the response policy list.

The second component has a function of receiving a third prompt and transmitting an analysis result to the third component, a function of receiving a fourth prompt and transmitting a correspondence table to the third component, and a function of receiving a fifth prompt and transmitting the response policy list to the third component. Furthermore, the second component has a function of performing processing with the large language model. The large language model has a function of generating the analysis result in accordance with the third prompt, a function of generating the correspondence table in accordance with the fourth prompt, and a function of generating the response policy list in accordance with the fifth prompt.

The third component has a function of receiving the specification and the cited reference and sharing the specification and the cited reference in the third component, and a function of receiving the response policy list and transmitting the response policy list to the first component.

The second subcomponent has a function of creating the third prompt, the fourth prompt, and the fifth prompt and transmitting the third prompt, the fourth prompt, and the fifth prompt to the second component.

The third prompt includes a third instruction, the specification, the scope of claims, the notice of reasons for refusal, and the cited reference. The third instruction includes a procedure for analyzing the notice of reasons for refusal with use of the specification, the scope of claims, and the cited reference to generate the analysis result.

The fourth prompt includes a fourth instruction and the analysis result. The fourth instruction includes a procedure for generating the correspondence table from the analysis result. The correspondence table includes a claim and a reason for refusal relating to the claim. Note that the claim is included in the scope of claims, and the reason for refusal is included in the notice of reasons for refusal.

The fifth prompt includes a fifth instruction, the analysis result, and the correspondence table. The fifth instruction includes a procedure for generating the response policy list, and a plurality of response policies for each reason for refusal are listed in the response policy list. Each of the response policies is provided with an advantage and a disadvantage.

Accordingly, the notice of reasons for refusal can be analyzed with use of the scope of claims, the specification, and the cited reference to generate the analysis result. Furthermore, a correspondence table where the claim and the reason for refusal are linked can be generated from the analysis result. Furthermore, a response policy list where a plurality of response policies are listed can be generated from the analysis result and the correspondence table and provided. Furthermore, each of the response policies can be provided with an advantage and a disadvantage. For example, the user of the data processing system can select any of the response policies with reference to the response policy list. As a result, a novel data processing system that is highly convenient, useful, or reliable can be provided.

(4) One embodiment of the present invention is a data processing method including a first phase. Note that the first phase includes a first step, a second step, a third step, a fourth step, a fifth step, a sixth step, a seventh step, and an eighth step.

In the first step of the first phase, a first component receives a scope of claims, a notice of reasons for refusal relating to the scope of claims, and a first argument draft relating to the notice of reasons for refusal and transmits the scope of claims, the notice of reasons for refusal, and the first argument draft to a second component.

In the second step of the first phase, the second component receives the scope of claims, the notice of reasons for refusal, and the first argument draft and shares the scope of claims, the notice of reasons for refusal, and the first argument draft in the second component. The second component includes a first subcomponent and a second subcomponent.

In the third step of the first phase, the first subcomponent extracts a first examination record list from a database in accordance with a first query.

The first query requires that a technical field match the scope of claims and requires that an examiner match a person in charge of the notice of reasons for refusal.

The database includes at least one examination record. The examination record includes a field for storing an argument record, a field for storing a notification record, a field for storing first information specifying an examiner in charge, and a field for storing second information specifying a technical field. Note that the notification record includes a decision on the argument record.

In the fourth step of the first phase, the second subcomponent creates a first prompt and transmits the first prompt to a third component.

The first prompt includes a first instruction, the first examination record list, and the first argument draft. The first instruction includes a procedure for generating a forecast with reference to the first examination record list.

In the fifth step of the first phase, the third component receives the first prompt and generates the forecast with use of a large language model.

In the sixth step of the first phase, the third component transmits the forecast to the second component.

In the seventh step of the first phase, the second component receives the forecast and transmits the forecast to the first component.

In the eighth step of the first phase, the first component provides the forecast.

Accordingly, a decision on the first argument draft by the examiner in charge of the notice of reasons for refusal can be forecasted. Furthermore, the decision can be forecasted with reference to the first examination record list relating to the examiner in charge of the notice of reasons for refusal. Furthermore, the decision can be forecasted from the argument record and the notification record stored in the first examination record list. Furthermore, for example, a user of a data processing system can reconsider the first argument draft with reference to the forecast. Furthermore, for example, the user of the data processing system can review a response policy with reference to the forecast. As a result, a novel data processing method that is highly convenient, useful, or reliable can be provided.

(5) Another embodiment of the present invention is the data processing method including a second phase. The first phase follows the second phase, and the second phase includes a first step, a second step, a third step, a fourth step, a fifth step, a sixth step, a seventh step, and an eighth step.

In the first step of the second phase, the first component receives a response policy, the scope of claims, and the notice of reasons for refusal and transmits the response policy, the scope of claims, and the notice of reasons for refusal to the second component.

In the second step of the second phase, the second component receives the response policy, the scope of claims, and the notice of reasons for refusal and shares the response policy, the scope of claims, and the notice of reasons for refusal in the second component.

In the third step of the second phase, the first subcomponent extracts a second examination record list from the database in accordance with a second query.

The second query requires that the technical field match the scope of claims, requires that the examiner match the person in charge of the notice of reasons for refusal, and requires that the argument record be equivalent to the response policy.

In the fourth step of the second phase, the second subcomponent creates a second prompt and transmits the second prompt to the third component.

The second prompt includes a second instruction and the second examination record list. The second instruction includes a procedure for generating a second argument draft with reference to the second examination record list.

In the fifth step of the second phase, the third component receives the second prompt and generates the second argument draft with use of the large language model.

In the sixth step of the second phase, the third component transmits the second argument draft to the second component.

In the seventh step of the second phase, the second component receives the second argument draft and transmits the second argument draft to the first component.

In the eighth step of the second phase, the first component provides the second argument draft.

Accordingly, the second argument draft can be generated on the basis of the response policy. Furthermore, for example, it is possible to generate such a second argument draft that the decision on the first argument draft can be overturned. Furthermore, for example, it is possible to generate such a second argument draft as to be likely to be accepted by the examiner in charge of the notice of reasons for refusal. As a result, a novel data processing method that is highly convenient, useful, or reliable can be provided.

(6) Another embodiment of the present invention is the data processing method including a third phase. The second phase follow the third phase, and the third phase includes a first step a second step, a third step, a fourth step, a fifth step, a sixth step, a seventh step, an eighth step, a ninth step, a tenth step, an eleventh step, a twelfth step, a thirteenth step, a fourteenth step, a fifteenth step, and a sixteenth step.

In the first step of the third phase, the first component receives the scope of claims, a specification relating to the scope of claims, the notice of reasons for refusal relating to the scope of claims, and a reference cited in the notice of reasons for refusal, and transmits the scope of claims, the specification, the notice of reasons for refusal, and the cited reference to the second component.

In the second step of the third phase, the second component receives the scope of claims, the specification, the notice of reasons for refusal, and the cited reference and shares the scope of claims, the specification, the notice of reasons for refusal, and the cited reference in the second component.

In the third step of the third phase, the second subcomponent creates a third prompt and transmits the third prompt to a third component.

The third prompt includes a third instruction, the specification, the scope of claims, the notice of reasons for refusal, and the cited reference. The third instruction includes a procedure for analyzing the notice of reasons for refusal with use of the specification, the scope of claims, and the cited reference to generate an analysis result.

In the fourth step of the third phase, the third component receives the third prompt and generates the analysis result with use of a large language model.

In the fifth step of the third phase, the third component transmits the analysis result to the second component.

In the sixth step of the third phase, the second component receives the analysis result and shares the analysis result in the second component.

In the seventh step of the third phase, the second subcomponent creates a fourth prompt and transmits the fourth prompt to the third component.

The fourth prompt includes a fourth instruction and the analysis result. The fourth instruction includes a procedure for generating the correspondence table from the analysis result. The correspondence table includes a claim and a reason for refusal relating to the claim. The claim is included in the scope of claims, and the reason for refusal is included in the notice of reasons for refusal.

In the eighth step of the third phase, the third component receives the fourth prompt and generates the correspondence table with use of the large language model.

In the ninth step of the third phase, the third component transmits the correspondence table to the second component.

In the tenth step of the third phase, the second component receives the correspondence table and shares the correspondence table in the second component.

In the eleventh step of the third phase, the second subcomponent creates a fifth prompt and transmits the fifth prompt to the third component.

The fifth prompt includes a fifth instruction, the analysis result, and the correspondence table. The fifth instruction includes a procedure for generating a response policy list. A plurality of response policies for each reason for refusal are listed in the response policy list. Each of the response policies is provided with an advantage and a disadvantage.

In the twelfth step of the third phase, the third component receives the fifth prompt and generates the response policy list with use of the large language model.

In the thirteenth step of the third phase, the third component transmits the response policy list to the second component.

In the fourteenth step of the first phase, the second component receives the response policy list and transmits the response policy list to the first component.

In the fifteenth step of the third phase, the first component receives the response policy list and provides the response policy list.

In the sixteenth step of the third phase, the first component stands by for an input of the response policy.

Accordingly, the notice of reasons for refusal can be analyzed with use of the scope of claims, the specification, and the cited reference to generate the analysis result. Furthermore, the correspondence table where the claim and the reason for refusal are linked can be generated from the analysis result. The response policy list where a plurality of response policies are listed can be generated from the analysis result and the correspondence table and provided. Furthermore, each of the response policies can be provided with an advantage and a disadvantage. For example, the user of the data processing system can select any of the response policies with reference to the response policy list. As a result, a novel data processing method that is highly convenient, useful, or reliable can be provided.

One embodiment of the present invention can provide a novel data processing system that is highly convenient, useful, or reliable. Alternatively, a novel data processing method that is highly convenient, useful, or reliable can be provided. Alternatively, a novel data processing system, a novel data processing method, or a novel semiconductor device can be provided.

Note that the description of these effects does not preclude the existence of other effects. Note that one embodiment of the present invention does not need to have all the effects. Note that other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1 illustrates a configuration of a data processing system of an embodiment.

FIG. 2 illustrates a configuration of a component used in a data processing system of an embodiment.

FIGS. 3A to 3C each illustrate a data configuration of a data processing system of an embodiment.

FIG. 4 illustrates a configuration of a prompt used in a data processing system of an embodiment.

FIG. 5 illustrates a configuration of a data processing system of an embodiment.

FIG. 6 illustrates a configuration of a component used in a data processing system of an embodiment.

FIG. 7 illustrates a configuration of a prompt used in a data processing system of an embodiment.

FIG. 8 illustrates a configuration of a data processing system of an embodiment.

FIG. 9 illustrates a configuration of a component used in a data processing system of an embodiment.

FIG. 10 illustrates a configuration of a prompt used in a data processing system of an embodiment.

FIG. 11A illustrates a configuration of a prompt used in a data processing system of an embodiment, and FIG. 11B illustrates a data configuration used in the data processing system thereof.

FIG. 12A illustrates a configuration of a prompt used in a data processing system of an embodiment, and FIG. 12B illustrates a data configuration used in the data processing system thereof.

FIG. 13 illustrates a configuration of a data processing device used for a data processing system of an embodiment.

FIG. 14 illustrates a data processing method of an embodiment.

FIG. 15 illustrates a data processing method of an embodiment.

FIG. 16 illustrates a data processing method of an embodiment.

FIG. 17 illustrates a data processing method of an embodiment.

FIG. 18 illustrates a data processing method of an embodiment.

FIG. 19 illustrates a data processing method of an embodiment.

### DETAILED DESCRIPTION OF THE INVENTION

A data processing system of one embodiment of the present invention includes a first component, a second component, and a third component.

The first component has a function of receiving a scope of claims, a notice of reasons for refusal relating to the scope of claims, and a first argument draft relating to the notice of reasons for refusal and transmitting them to the third component. In addition, the first component has a function of receiving a forecast and providing it.

The second component has a function of receiving a first prompt and transmitting the forecast to the third component. Furthermore, the second component has a function of performing processing with use of a large language model. The large language model has a function of generating the forecast in accordance with the first prompt.

The third component has a function of receiving the scope of claims, the notice of reasons for refusal, and the first argument draft and shares them in the third component. In addition, the third component has a function of receiving the forecast and transmitting it to the first component. The third component includes a first subcomponent and a second subcomponent.

The first component has a function of performing processing with a database and a search engine.

The database includes one or more examination records. The examination record includes a field for storing an argument record, a field for storing a notification record, a field for storing first information specifying an examiner in charge, and a field for storing second information specifying a technical field. Note that the notification record includes a decision on the argument record.

The search engine has a function of extracting a first examination record list from the database in accordance with the first query. The first query requires that the technical field match the scope of claims and requires that the examiner match a person in charge of the notice of reasons for refusal.

The second subcomponent has a function of creating the first prompt and transmitting it to the second component.

The first prompt includes a first instruction, the first examination record list, the notice of reasons for refusal, and the first argument draft. The first instruction includes a procedure for generating the forecast with reference to the first examination record list. Note that the forecast includes the decision on the first argument draft.

Accordingly, the decision on the first argument draft by the examiner in charge of the notice of reasons for refusal can be forecasted. Furthermore, the decision can be forecasted with reference to the first examination record list relating to the examiner in charge of the notice of reasons for refusal. Furthermore, the decision can be forecasted from the argument record and the notification record stored in the first examination record list. Furthermore, for example, a user of the data processing system can reconsider the first argument draft with reference to the forecast. Furthermore, for example, the user of the data processing system can review a response policy with reference to the forecast. As a result, a novel data processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in structures of the invention described below, the same portions or portions having similar functions are denoted by the same reference numerals in different drawings, and the description thereof is not repeated.

Ordinal numbers such as “first” and “second” in this specification and the like are used in order to avoid confusion among components. Thus, the terms do not limit the number of components or the order of components (e.g., the order of steps or the stacking order of layers). A term without an ordinal number in this specification and the like may be described with an ordinal number in a claim in order to avoid confusion among components. A term with an ordinal number in this specification and the like may be described with a different ordinal number in a claim. A term with an ordinal number in this specification and the like may be described without an ordinal number in a claim.

Although a block diagram in which components are classified by their functions and shown as independent blocks is shown in the drawing attached to this specification, it is difficult to completely separate actual components according to their functions and one component can relate to a plurality of functions.

### Embodiment 1

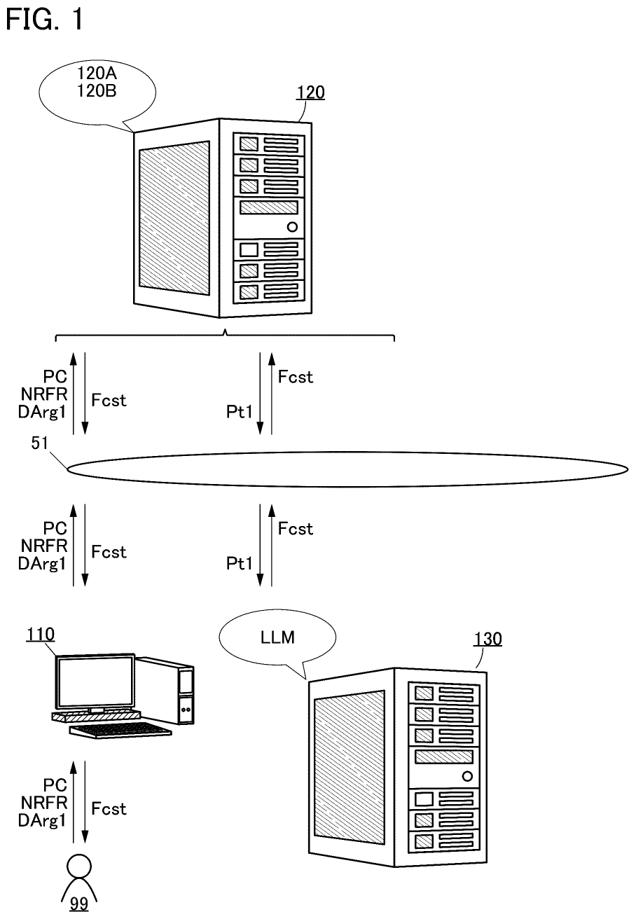

In this embodiment, a data processing system of one embodiment of the present invention will be described with reference to FIG. 1 to FIG. 13.

FIG. 1 illustrates a configuration of the data processing system of one embodiment of the present invention.

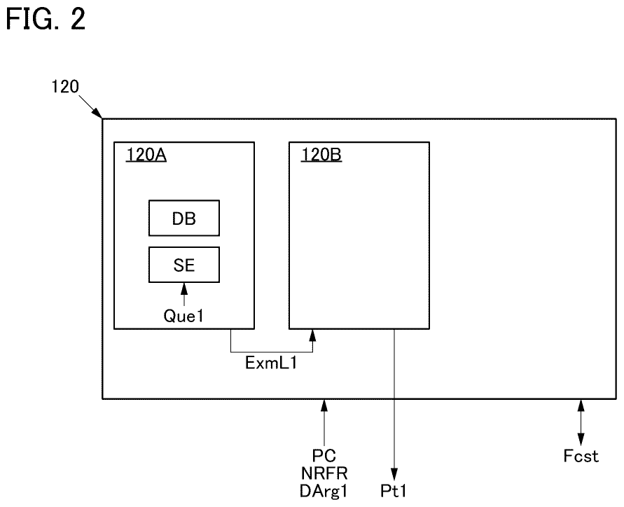

FIG. 2 illustrates a configuration in a component used in the data processing system of one embodiment of the present invention.

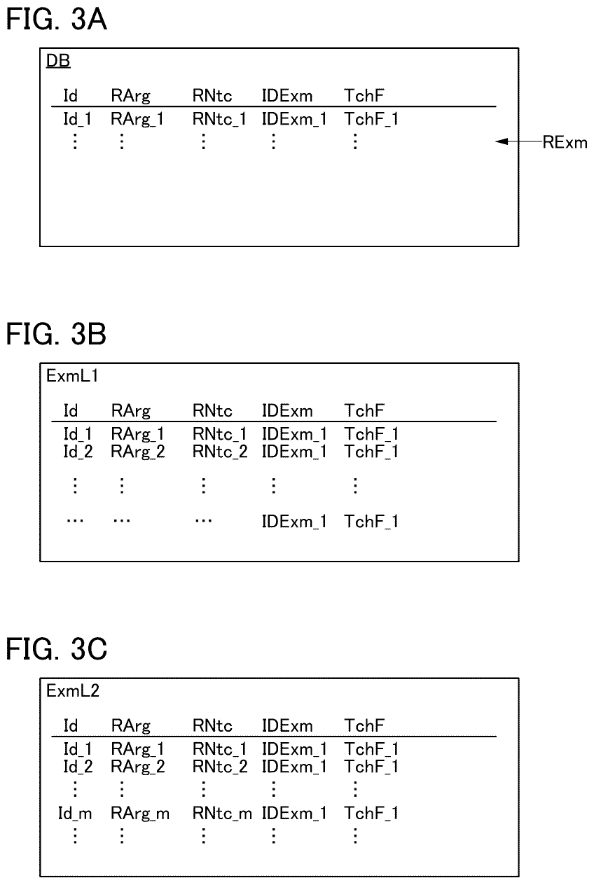

FIG. 3A illustrates a configuration of a database used for the data processing system of one embodiment of the present invention; FIG. 3B illustrates a configuration of an examination record list extracted from the database; and FIG. 3C illustrates a configuration of an examination record list different from the examination record list illustrated in FIG. 3B.

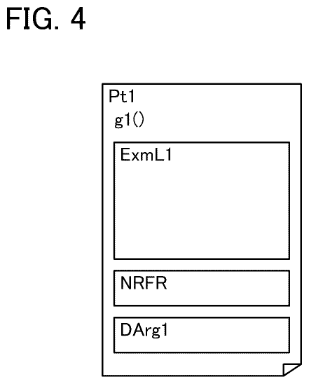

FIG. 4 illustrates a configuration of a prompt transmitted and received in the data processing system of one embodiment of the present invention.

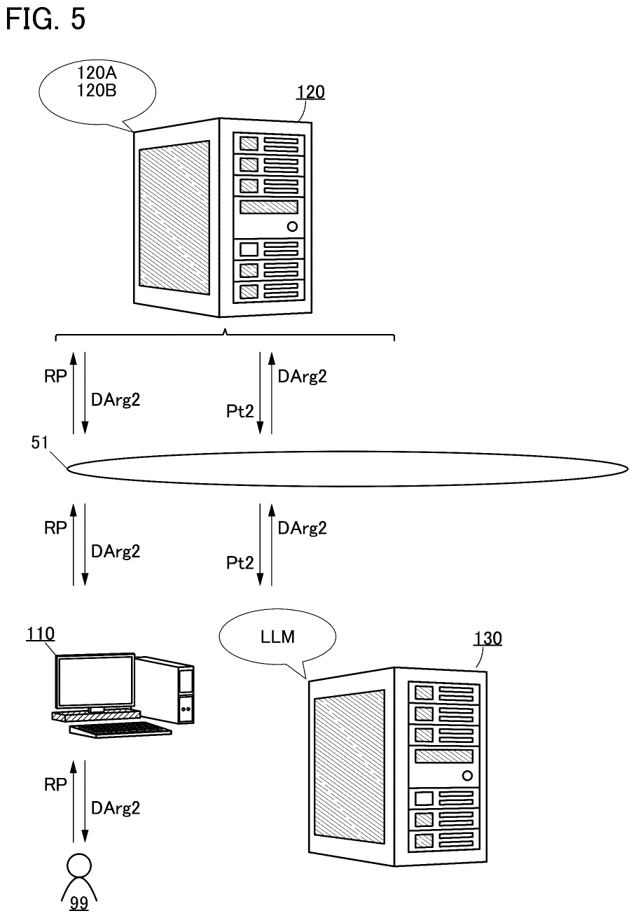

FIG. 5 illustrates a configuration of a data processing system of one embodiment of the present invention.

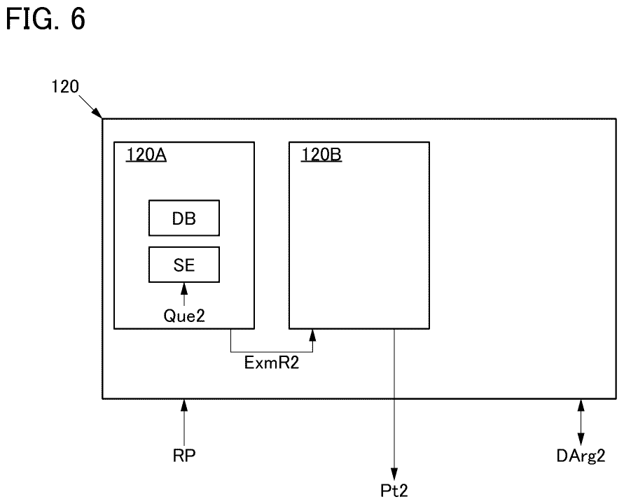

FIG. 6 illustrates a configuration in a component used in the data processing system of one embodiment of the present invention.

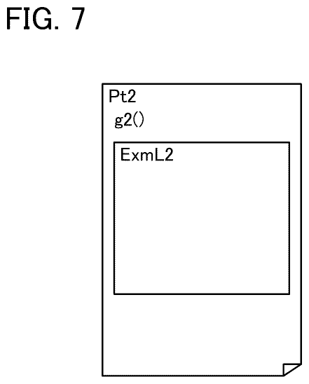

FIG. 7 illustrates a configuration of a prompt transmitted and received inside the data processing system of one embodiment of the present invention.

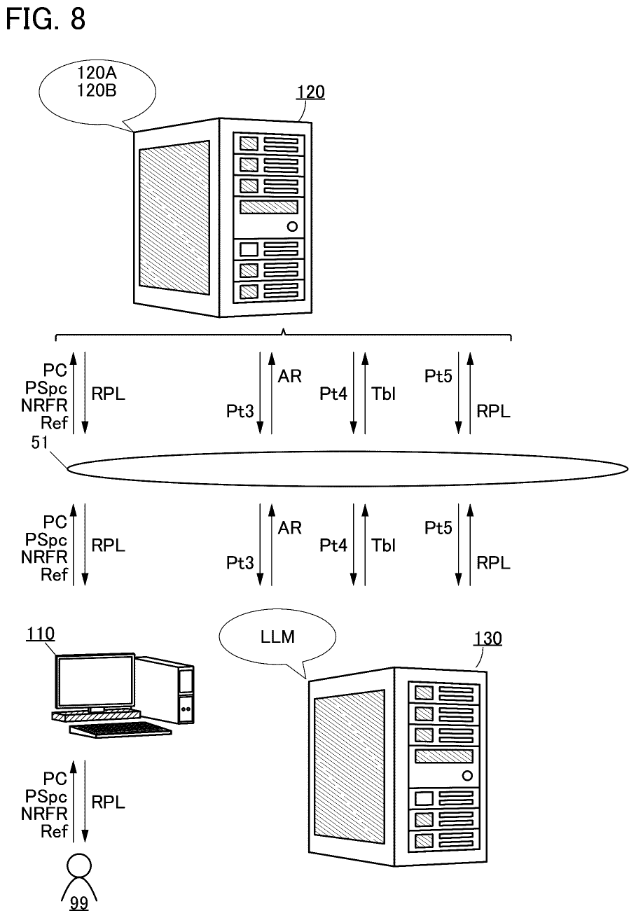

FIG. 8 illustrates a configuration of a data processing system of one embodiment of the present invention.

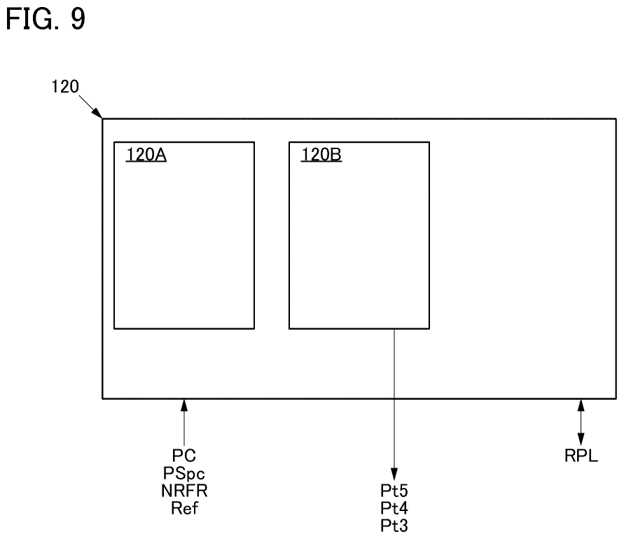

FIG. 9 illustrates a configuration in a component used in the data processing system of one embodiment of the present invention.

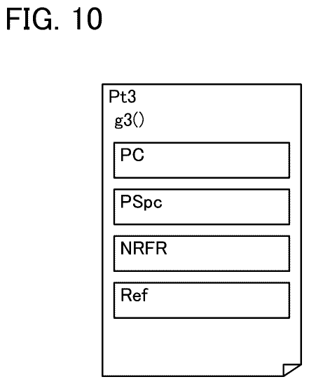

FIG. 10 illustrates a configuration of a prompt transmitted and received inside the data processing system of one embodiment of the present invention.

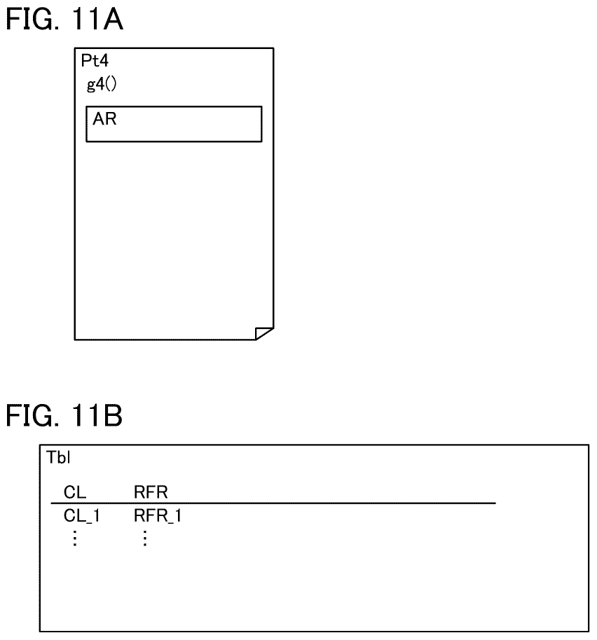

FIG. 11A illustrates a configuration of a prompt transmitted and received inside the data processing system of one embodiment of the present invention, and FIG. 11B illustrates a configuration of a generated correspondence table.

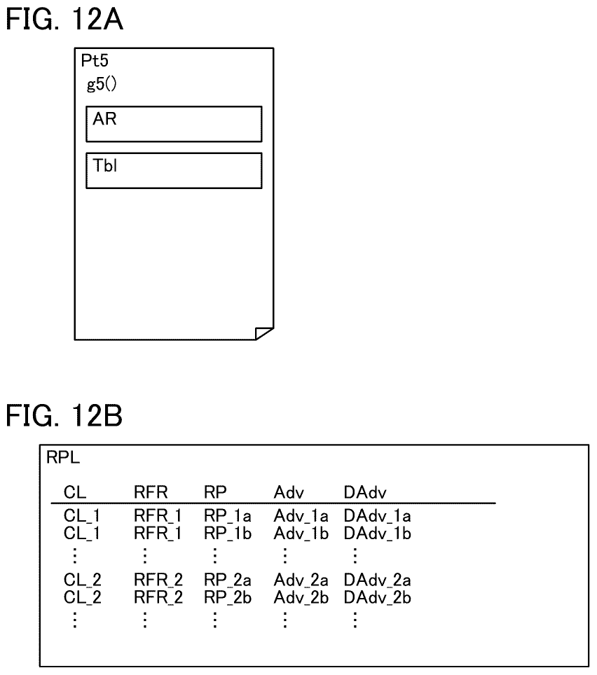

FIG. 12A illustrates a configuration of a prompt transmitted and received inside the data processing system of one embodiment of the present invention, and FIG. 12B illustrates a configuration of a generated response policy list.

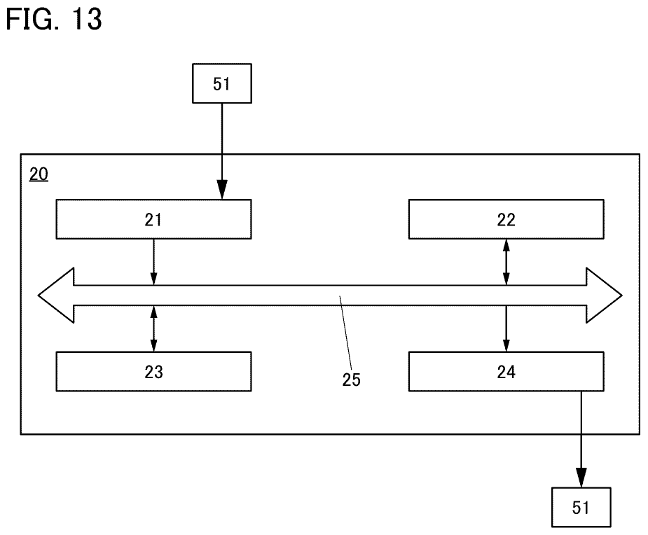

FIG. 13 is a block diagram illustrating a configuration of a data processing device which can be used for the data processing system of one embodiment of the present invention.

### <Configuration Example 1 of Data Processing System>

The data processing system described in this embodiment includes a component 110, a component 130, and a component 120 (see FIG. 1). A data processing device fulfilling a function of the component 110, a data processing device fulfilling a function of the component 130, and a data processing device fulfilling a function of the component 120 each include an arithmetic device and a communication device. The communication devices can be connected to each other using a network 51, for example, to construct the data processing system of one embodiment of the present invention.

### <Configuration Example 1 of Component 110>

The component 110 has a function of receiving a scope of claims PC, a notice of reasons for refusal NRFR, and an argument draft DArg1 and transmitting them to the component 120. The notice of reasons for refusal NRFR relates to the scope of claims PC, and the argument draft DArg1 relates to the notice of reasons for refusal NRFR.

For example, a scope of claims that have been requested for examination of a patent application can be used as the scope of claims PC. A notice of reasons for refusal issued for the scope of claims can be used as the notice of reasons for refusal NRFR. An argument draft that is a response to the notice of reasons for refusal NRFR can be used as the argument draft DArg1.

For example, a user 99 of the data processing system inputs the scope of claims PC, the notice of reasons for refusal NRFR, and the argument draft DArg1 to the component 110. Specifically, the user of the data processing system inputs them to the component 110 with use of an input device such as a keyboard, a pointing device, an eye-gaze input device, or a microphone.

The component 110 has a function of receiving a forecast Fcst from the component 120 and providing it to the user 99 of the data processing system. Specifically, with use of an output device such as a display device, a speaker, a printer, or a memory device, the forecast Fcst is provided for the user 99 of the data processing system.

### <Configuration Example 1 of Component 130>

The component 130 has a function of receiving a prompt Pt1, a function of transmitting the forecast Fcst to the component 120, and a function of performing processing using a large language model LLM.

### <<Configuration Example 1 of Large Language Model LLM

The large language model LLM has a function of generating the forecast Fcst in accordance with the prompt Pt1.

For example, a large language model such as GPT-3 (registered trademark), GPT-3.5, GPT-4 (registered trademark), LaMDA, Llama2, or Llama3 can be used as the large language model LLM.

### <Configuration Example 1 of Component 120>

The component 120 has a function of receiving, from the component 110, the scope of claims PC, the notice of reasons for refusal NRFR, and the argument draft DArg1 and sharing them in the component 120, for example (see FIG. 2).

The component 120 has a function of receiving the forecast Fcst and transmitting it to the component 110.

The component 120 includes a subcomponent 120A and a subcomponent 120B. Note that in this specification, a structure having a single function or a plurality of functions is referred to as a component or a subcomponent for description convenience.

### <<Configuration Example 1 of Subcomponent 120A>>

The subcomponent 120A has a function of executing processing using a database DB and a search engine SE.

### [Configuration Example of Database DB]

The database DB includes one or more examination records RExm (see FIG. 3A). Note that one row shown in the drawing corresponds to one examination record RExm. Note that the examination record RExm can be obtained from the Patent Office of the country to which a patent application is filed, for example.

The examination record RExm includes a field for storing identification information Id, a field for storing an argument record RArg, a field for storing a notification record RNtc, a field for storing information IDExm specifying an examiner in charge, and a field for storing information TchF specifying a technical field. Note that the notification record RNtc includes a decision on the argument record RArg.

### [Configuration Example 1 of Search Engine SE]

The search engine SE has a function of extracting an examination record list ExmL1 from the database DB in accordance with a query Que1 (see FIG. 3B). Note that the query Que1 requires that the technical field match the scope of claims PC and requires that the examiner match the person in charge of the notice of reasons for refusal NRFR.

For example, in the examination record list ExmL1, all the fields for storing information TchF specifying a technical field are a technical field TchF_1. In addition, all the fields for storing information IDExm specifying an examiner in charge are an examiner IDExm_1.

An amendment and an argument accepted in a case whose identification information Id is Id_1 are recorded in the argument record RArg_1. A decision, by the examiner IDExm_1, on the argument recorded in the argument record RArg_1 is recorded in the notification record RNtc_1.

### <<Configuration Example 1 of Subcomponent 120B>>

The subcomponent 120B has a function of creating the prompt Pt1 and transmitting it to the component 130.

### [Configuration Example of Prompt Pt1]

The prompt Pt1 includes an instruction g1( ), the examination record list ExmL1, and the argument draft DArg1 (see FIG. 4). In addition, it is preferable to include the notice of reasons for refusal NRFR. The instruction g1( ) includes a procedure for generating the forecast Fcst with reference to the examination record list ExmL1.

The forecast Fcst includes a decision on the argument draft DArg1. Specifically, the forecast Fcst can adopt a decision that the argument draft DArg1 can overcome a reason for refusal RFR described in the notice of reasons for refusal NRFR. Alternatively the forecast Fcst can adopt a decision that the argument draft DArg1 cannot overcome the reason for refusal RFR described in the notice of reasons for refusal NRFR.

The examination record list ExmL1 is extracted from the database DB with use of the information TchF specifying a technical field and the information IDExm specifying an examiner for the query Que1. The argument record RArg and the notification record RNtc extracted into the examination record list ExmL1 are included in the prompt Pt1, whereby the large language model LLM can perform in-context learning of the tendency of decision by the examiner specified by the information IDExm, specifically, the tendency of response to the argument.

For example, text in the next paragraph can be used as the prompt Pt1.
“##argument: argument record RArg_1
##notice letter: notification record RNtc_1
##argument: argument record RArg_2
##notice letter: notification record RNtc_2

The examiner has the tendency shown above.

Create a notice letter that is an examiner's response to the following argument draft DArg1.
##argument: argument draft DArg1
##notice letter:”

The above “##argument:” is a headline, and the “argument record RArg_1” and the “argument record RArg_2” each following the “##argument:” are the argument record RArg extracted into the examination record list ExmL1. The “argument draft DArg1” following the “##argument:” is an argument draft subjected to processing where the large language model LLM inferring the examiner's decision.

The above “##notice letter:” is a headline, and the “notification record RNtc_1” and the “notification record RNtc_2” following the “##notice letter” are the notification record RNtc extracted into the examination record list ExmL1. The “notification record RNtc_1” following the “##notice letter” is a record of notification that is the examiner's response to the “argument record RArg_1”, and the “notification record RNtc_2” is a record of notification that is the examiner's response to the “argument record RArg_2”.

The “##notice letter” listed at the end is a headline activating an output by the large language model LLM. The sentences “The examiner has the tendency shown above. Create a notice letter that is an examiner's response to the following argument draft DArg1.” are a portion corresponding to the instruction g1( ).

Accordingly, the decision on the argument draft DArg1 by the examiner in charge of the notice of reasons for refusal NRFR can be forecasted. In addition, the decision can be forecasted with reference to the examination record list ExmL1 of the examiner in charge of the notice of reasons for refusal NRFR. Moreover, the decision can be forecasted from the argument record RArg and the notification record RNtc stored in the examination record list ExmL1. For example, the user of the data processing system can reconsider the argument draft DArg1 with reference to the forecast Fcst. Furthermore, for example, the user of the data processing system can review a response policy RP with reference to the forecast Fcst. As a result, a novel data processing system that is highly convenient, useful, or reliable can be provided.

### <Configuration Example 2 of Data Processing System>

Another data processing system described in this embodiment includes the component 110, the component 130, and the component 120 (see FIG. 5). The data processing system illustrated in FIG. 5 generates an argument draft DArg2 on the basis of the response policy RP which the user of the data processing system inputs, for example.

### <Configuration Example 2 of Component 110>

The component 110 has a function of receiving the response policy RP and transmitting it to the component 120. For example, the user 99 of the data processing system inputs the response policy RP to the component 110. Specifically, the user of the data processing system inputs the response policy RP to the component 110 with use of an input device such as a keyboard, a pointing device, or an eye-gaze input device.

The component 110 has a function of receiving the argument draft DArg2 from the component 120 and providing it to the user 99 of the data processing system, for example.

### <Configuration Example 2 of Component 130>

The component 130 has a function of receiving a prompt Pt2 and transmitting the argument draft DArg2 to the component 120, and a function of performing processing with use of the large language model LLM.

### <<Configuration Example 2 of Large Language Model LLM>>

The large language model LLM has a function of generating the argument draft DArg2 in accordance with the prompt Pt2.

### <Configuration Example 2 of Component 120>

The component 120 has a function of receiving the response policy RP from the component 110 and sharing it in the component 120, for example (see FIG. 6).

The component 120 has a function of receiving the argument draft DArg2 and transmitting it to the component 110.

### [Configuration Example 2 of Search Engine SE]

The search engine SE has a function of extracting an examination record list ExmL2 from the database DB in accordance with a query Que2 (see FIG. 3C). The query Que2 requires that the technical field match the scope of claims PC, requires that the examiner match the person in charge of the notice of reasons for refusal NRFR, and requires that the argument record RArg be equivalent to the response policy RP. Furthermore, the query Que2 can require that the examiner have not found a reason for refusal in the submitted argument.

For example, in the examination record list ExmL2, all the fields for storing the information TchF specifying a technical field are the technical field TchF_1. All the fields for storing information IDExm specifying an examiner in charge are the examiner IDExm_1.

The argument record RArg_1 stored in the field for storing an argument record RArg is equivalent to the response policy RP. Similarly, the argument record RArg_m stored in the field storing the argument record RArg is equivalent to the response direction RP. For example, for the response policy RP, a policy of overcoming a notified reason for refusal by amendment of the scope of claims or a policy of overcoming a notified reason for refusal by rebutting the notified reason for refusal can be adopted.

An amendment and an argument accepted in a case whose identification information Id is Id_1 are recorded in the argument record RArg_1. A decision, by the examiner IDExm_1, on the argument recorded in the argument record RArg_1 is recorded in the notification record RNtc_1.

An amendment and an argument accepted in a case whose identification information Id is Id_m are recorded in the argument record RArg_m. A decision, by the examiner IDExm_1, on the argument recorded in the argument record RArg_m is recorded in the notification record RNtc_m.

### <<Configuration Example 2 of Subcomponent 120B>>

The subcomponent 120B has a function of creating the prompt Pt2 and transmitting it to the component 130.

### [Configuration Example of Prompt Pt2]

The prompt Pt2 includes an instruction g2( ) and the examination record list ExmL2 (see FIG. 7). The instruction g2( ) includes a procedure for generating the argument draft DArg2 with reference to the examination record list ExmL2.

For example, text in the next paragraph can be used as the prompt Pt2.
“##notice letter: notification record RNtc_1
##argument: argument record RArg_1
##notice letter: notification record RNtc_2
##argument: argument record RArg_2

The above is exchanges in a case where the examiner grants an allowance to the argument submitted in response to the notice letter. Create an argument to which the examiner is likely to grant an allowance, with reference to the above, in response to the following notice letter.
##notice letter: notice of reasons for refusal NRFR
##argument: ”

The above “##notice letter:” is a headline, and “notification record RNtc_1” and “notification record RNtc_2” each following “##notice letter:” are the notification record RNtc extracted into the examination record list ExmL2. The “notice of reasons for refusal NRFR” following the “##notice letter:” is a notice letter that is an object of the argument draft DArg2 which the large language model LLM creates.

The above “##argument:” is a headline, and the “argument record RArg_1” and “argument record RArg_2” each following the “##argument:” are the argument record RArg extracted into the examination record list ExmL2. The “argument record RArg_1” following the “##argument:” is a record of the argument that is the applicant's response to the notification record RNtc_1, and the “argument record RArg_2” is a record of the argument that is the applicant's response to the notification record RNtc_2.

The “##argument:” listed at the end is a headline activating an output by the large language model LLM. The sentences “The above is exchanges in a case where the examiner grants an allowance to the argument submitted in response to the notice letter. Create an argument to which the examiner is likely to grant an allowance, with reference to the above, in response to the following notice letter.” are a portion corresponding to the instruction g2( ).

Accordingly, the argument draft DArg2 can be generated on the basis of the response policy RP. For example, the argument draft DArg2 overturning a decision on the argument draft DArg1 can be generated. For example, the argument draft DArg2 which the examiner in charge of the notice of reasons for refusal NRFR is likely to accept can be generated. As a result, a novel data processing system that is highly convenient, useful, or reliable can be provided.

### <Configuration Example 3 of Data Processing System>

Another data processing system described in this embodiment includes the component 110, the component 130, and the component 120 (see FIG. 8). The data processing system illustrated in FIG. 8 can analyze the notice of reasons for refusal NRFR with use of the scope of claims PC, a specification PSpc, and a cited reference Ref to generate a correspondence table Tb1 where a claim CL and the reason for refusal RFR are linked. In addition, the data processing system can create a response policy list RPL where a plurality of the response policies RP are listed from an analysis result AR and the correspondence table Tb1 and provide the response policy list RPL together with an advantage and a disadvantage of each policy to the user 99 of the data processing system, for example.

### <Configuration Example 3 of Component 110>

The component 110 has a function of receiving the specification PSpc relating to the scope of claims PC and the cited reference Ref relating to the notice of reasons for refusal NRFR and transmitting them to the component 120.

For example, the user 99 of the data processing system inputs the scope of claims PC, the specification PSpc, the notice of reasons for refusal NRFR, and the cited reference Ref to the component 110. Specifically, the user of the data processing system inputs them to the component 110 with use of an input device such as a keyboard, a pointing device, or an eye-gaze input device. For an input to the data processing system, a file where information is recorded, a path designating a destination to save a file where information is recorded, or the like can be used.

The component 110 has a function of receiving the response policy list RPL from the component 120 and providing it to the user 99 of the data processing system, for example.

### <Configuration Example 3 of Component 130>

The component 130 has a function of receiving a prompt Pt3 and transmitting the analysis result AR to the component 120, a function of receiving a prompt Pt4 and transmitting the correspondence table Tb1 to the component 120, and a function of receiving a prompt Pt5 and transmitting the response policy list RPL to the component 120. In addition, the component 130 has a function of performing processing with use of the large language model LLM.

### <<Configuration Example 3 of Large Language Model LLM

The large language model LLM has a function of generating the analysis result AR in accordance with the prompt Pt3, a function of generating the correspondence table Tb1 in accordance with the prompt Pt4, and a function of generating the response policy list RPL in accordance with the prompt Pt5.

### <Configuration Example 3 of Component 120>

The component 120 has a function of receiving the scope of claims PC, the specification PSpc, the notice of reasons for refusal NRFR, and the cited reference Ref from the component 110 and sharing them in the component 120, for example (see FIG. 9).

In addition, the component 120 has a function of receiving the response policy list RPL and transmitting it to the component 110.

### <Configuration Example 3 of Subcomponent 120B>

The subcomponent 120B has a function of creating the prompt Pt3, the prompt Pt4, and the prompt Pt5 and transmitting them to the component 130.

### [Configuration Example of Prompt Pt3]

The prompt Pt3 includes an instruction g3( ), the specification PSpc, the scope of claims PC, the notice of reasons for refusal NRFR, and the cited reference Ref (see FIG. 10). The instruction g3( ) includes a procedure for analyzing the notice of reasons for refusal NRFR with use of the specification PSpc, the scope of claims PC, and the cited reference Ref to generate the analysis result AR. The analysis result AR includes an abstract of the notice of reasons for refusal NRFR.

For example, text in the next paragraph can be used as the prompt Pt3.
“##scope of claims: scope of claims PC
##specification: specification PSpc
##notice letter: notice of reasons for refusal NRFR
##cited reference: cited reference Ref

Execute the following analysis on the notice of reasons for refusal NRFR with use of the specification PSpc, the scope of claims PC, and the cited reference Ref to create the analysis result AR.

Explain the summary of the notice of reasons for refusal NRFR.

Summarize the abstract of each reason for refusal of the notice of reasons for refusal NRFR and the cited reference Ref relating to the corresponding scope of claims PC.
##analysis result:”

The above “##scope of claims:” and “##specification:” are headlines, and the “specification PSpc” following the “##specification:” is the specification relating to the invention described in the scope of claims PC. Moreover, the “##notice letter:” and the “##cited reference:” are headlines, and the “cited reference Ref” following the “##cited reference:” is a cited reference described in the notice of reasons for refusal NRFR.

The “##analysis result:” listed at the end is a headline activating an output by the large language model LLM. The sentences “Execute the following analysis on the notice of reasons for refusal NRFR with use of the specification PSpc, the scope of claims PC, and the cited reference Ref to create the analysis result AR. Explain the summary of the notice of reasons for refusal NRFR. Summarize the abstract of each reason for refusal of the notice of reasons for refusal NRFR and the cited reference Ref relating to the corresponding scope of claims PC.” are a portion corresponding the instruction g3( ).

### [Configuration Example of Prompt Pt4]

The prompt Pt4 includes an instruction g4( ) and the analysis result AR (see FIG. 11A). The instruction g4( ) includes a procedure for generating the correspondence table Tb1 from the notice of reasons for refusal NRFR, the scope of claims PC, and the analysis result AR. The correspondence table Tb1 includes the claim CL and the reason for refusal RFR relating to the claim CL (see FIG. 11B). The claim CL is included in the scope of claims PC, and the reason for refusal RFR is included in the notice of reasons for refusal NRFR. For example, the reason for refusal RFR_1 is a reason for which a patent is not granted for the claim CL_1.

For example, text in the next paragraph can be used as the prompt Pt4.
“##scope of claims: scope of claims PC
##notice letter: notice of reasons for refusal NRFR
##analysis result: analysis result AR

Create the correspondence table Tb1 from the above analysis result AR.
##correspondence table:”

The above “##scope of claims:”, “##notice letter:”, and “##analysis result:” are headlines, and the “analysis result AR” following the “##analysis result:” is the above analysis result AR.

The “##correspondence table:” listed at the end is a headline activating an output by the large language model LLM. The sentence “Create the correspondence table Tb1 from the above analysis result AR.” is a portion corresponding to the instruction g4( ).

### [Configuration Example of Prompt Pt5]

The prompt Pt5 includes an instruction g5( ), the analysis result AR, and the correspondence table Tb1 (see FIG. 12A). The instruction g5( ) includes a procedure for generating the response policy list RPL. For each reason for refusal RFR in the response policy list RPL, a plurality of the response policies RP are listed (see FIG. 12B). For each response policy RP, an advantage Adv and a disadvantage DAdv are given.

For example, the reason for refusal RFR_1 is a reason for which a patent is not granted for the claim CL_1, and a response policy RP_1a and a response policy RP_1b are each a policy of overcoming the reason for refusal RFR_1. An advantage Adv_1a is an advantage of the response policy RP_1a, and a disadvantage DAdv_1a is a disadvantage of the response policy RP_1a. Similarly, an advantage Adv_1b is an advantage of a response policy RP_1b, and a disadvantage DAdv_1b is a disadvantage of the response policy RP_1b.

For example, the reason for refusal RFR_2 is a reason for which a patent is not granted for the claim CL_2, and a response policy RP_2a and a response policy RP_2b are each a policy of overcoming the reason for refusal RFR_2. An advantage Adv_2a is an advantage of the response policy RP_2a, and a disadvantage DAdv_2a is a disadvantage of the response policy RP_2a. Similarly, an advantage Adv_2b is an advantage of the response policy RP_2b, and a disadvantage DAdv_2b is a disadvantage of the response policy RP_2b.

For example, test in the next paragraph can be used as the prompt Pt5.
“##analysis result: analysis result AR
##correspondence table: correspondence table Tb1

Make a proposal for a plurality of response policies of each reason for refusal of each claim. Give an advantage and a disadvantage of each response policy and create the response policy list RPL.
##response policy list:”

The above “##analysis result:” and “##correspondence table:” are headlines, the “analysis result AR” following the “##analysis result:” is the above analysis result AR, and the “correspondence table Tb1” following the “##correspondence table:” is the above correspondence table Tb1.

The “##response policy list:” listed at the end is a headline activating an output by the large language model LLM. The sentences “Make a proposal for a plurality of response policies of each reason for refusal of each claim. Give an advantage and a disadvantage of each response policy and create a response policy list RPL.” are a portion corresponding to the instruction g5( ).

Accordingly, the notice of reasons for refusal NRFR can be analyzed with use of the scope of claims PC, the specification PSpc, and the cited reference Ref to generate the analysis result AR. In addition, the correspondence table Tb1 where the claim CL and the reason for refusal RFR are linked can be generated from the analysis result AR. Moreover, the response policy list RPL where a plurality of response policies RP are listed can be generated from the analysis result AR and the correspondence table Tb1 and provided. Furthermore, an advantage and a disadvantage can be given to each response policy RP. Furthermore, the user of the data processing system can select the response policy RP with reference to the response policy list RPL. As a result, a novel data processing system that is highly convenient, useful, or reliable can be provided.

### <Configuration Example 4 of Data Processing System>

Another data processing system described in this embodiment includes the component 110, the component 120, and the component 130 (see FIG. 1).

The data processing system of one embodiment of the present invention can be composed of a data processing device having a function of the component 110, a data processing device having a function of the component 120, and a data processing device having a function of the component 130, for example. Note that the number of data processing devices constituting the data processing system of one embodiment of the present invention is one or more. For example, a plurality of data processing devices can be connected to each other using the network 51 to construct the data processing system of one embodiment of the present invention.

When the data processing system of one embodiment of the present invention is constituted with the plurality of data processing devices, loads relating to data processing can be dispersed.

### <Configuration Example 1 of Data Processing Device>

A configuration example 1 of the data processing device described in this embodiment can be used as the component 110. The configuration example 1 of the data processing device can be referred to as a client computer or the like. For example, a desktop computer can be used as the component 110.

The configuration example 1 of the data processing device can receive data input by the user of the data processing system of one embodiment of the present invention. The configuration example 1 of the data processing device can provide data output from the data processing system of one embodiment of the present invention to the user.

For example, dedicated application software or a web browser operates in the component 110. Via either of them, the user of the data processing system of one embodiment of the present invention can access the data processing system. Thus, the user can receive service using the data processing system of one embodiment of the present invention.

### <Configuration Example 2 of Data Processing Device>

This configuration example 2 of the data processing device described in this embodiment can be used as the component 120. For example, a workstation, a server computer, or a supercomputer can be used as the component 120.

The configuration example 2 of the data processing device preferably has a function of a parallel computer. When the data processing device with this configuration is used as a parallel computer, large-scale computation necessary for artificial intelligence (AI) learning and inference can be performed, for example.

Furthermore, the configuration example 2 of the data processing device can perform processing using a natural language processing model with use of AI.

For example, processing using a natural language model such as GPT-3 (registered trademark), GPT-3.5, GPT-4 (registered trademark), LaMDA, or Llama2, Llama3 can be performed.

### <Configuration Example 3 of Data Processing System Device>

The configuration example 3 of the data processing device described in this embodiment can be used as the component 130, for example. Note that the component 130 has a larger scale and higher computational capability than the component 120. For example, a large computer such as a server computer or a supercomputer can be used as the component 130.

The configuration example 3 of the data processing device preferably has a function of a parallel computer. When the data processing device with this configuration is used as a parallel computer, large-scale computation necessary for AI learning and inference can be performed, for example.

Furthermore, the configuration example 3 of the data processing device can perform processing using a natural language processing model with use of AI. In particular, it is possible to perform processing using a general-purpose language processing model capable of performing a variety of natural language processing tasks.

For example, processing using a natural language model such as GPT-3 (registered trademark), GPT-3.5, GPT-4 (registered trademark), LaMDA, Llama2, or Llama3 can be performed. In particular, it is preferable that processing using GPT-4 (registered trademark) be available. For example, processing using a language model that is larger in scale than a conventional natural language model can achieve more natural text generation, interaction, or the like.

Note that a service provider using the data processing system of one embodiment of the present invention does not necessarily have its own configuration example 3 of the data processing device. For example, a service provider can utilize part of the service that another company or the like provides using the configuration example 3 of the data processing device.

### <Configuration Example of Network 51>

The network 51 that can be used for the data processing system of one embodiment of the present invention can connect the plurality of data processing devices to each other. Thus, the plurality of data processing devices connected to each other can transmit and receive data to and from each other. Furthermore, loads of the data processing can be dispersed.

Note that for wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can also be used as the network 51. For another example, a personal area network (PAN), a local area network (LAN), a campus area network (CAN), a metropolitan area network (MAN), a wide area network (WAN), or a global area network (GAN) can be used as the network 51.

For example, a global network can be used as the network 51. Specifically, the Internet, which is an infrastructure of the World Wide Web (WWW), can be used.

Furthermore, the service provider using the data processing system of one embodiment of the present invention can provide service using the data processing method of one embodiment of the present invention via the network 51, for example.

Note that in the case where the data processing system of one embodiment of the present invention is constructed in a local network, the possibility of leakage of confidential information can be lower than that in the case of using the Internet, for example.

### <Configuration Example 4 of Data Processing Device>

A data processing device 20 that can be used for the data processing system of one embodiment of the present invention includes, for example, an input unit 21, a storage unit 22, a processing unit 23, an output unit 24, and a transmission path 25 (see FIG. 13).

Although the block diagram in drawings attached to this specification illustrates components classified by their functions in independent blocks, it is difficult to classify actual components by their functions completely, and one component can have a plurality of functions. For example, part of the processing unit 23 functions as the input unit 21 in some cases. In addition, one function can be involved in a plurality of components. For example, processing performed in the processing unit 23 is sometimes executed by a different data processing device depending on the processing.

### <<Input Unit 21>>

The input unit 21 can receive data from the outside of the data processing device. For example, the input unit 21 receives data via the network 51.

The input unit 21 supplies the received data to one or both of the storage unit 22 and the processing unit 23 via the transmission path 25.

### <<Storage Unit 22>>

The storage unit 22 has a function of storing a program to be executed by the processing unit 23. The storage unit 22 can also have a function of storing data generated by the processing unit 23 (e.g., an arithmetic operation result, an analysis result, or an inference result), data received by the input unit 21, and the like.

The storage unit 22 can include a database. The data processing device can include a database in addition to the storage unit 22. The data processing device can have a function of extracting data from a database outside the storage unit 22, the data processing device, or the data processing system. Alternatively, the data processing device can have a function of extracting data from both of its own database and an external database.

One or both of a storage and a file server can be used as the storage unit 22. In addition, a database in which a path of a file stored in the file server is recorded can be used as the storage unit 22.

The storage unit 22 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase change random access memory (PRAM), a ferroelectric random access memory (FeRAM), a magnetoresistive random access memory (MRAM, also referred to as a magnetoresistive memory), and a flash memory. The storage unit 22 can include at least one of a NOSRAM (registered trademark) and a DOSRAM (registered trademark). The storage unit 22 can include a storage media drive. Examples of the storage media drive include a hard disk drive (HDD) and a solid state drive (SSD).

Note that the NOSRAM is an abbreviation for “nonvolatile oxide semiconductor random access memory (RAM)”. The NOSRAM refers to a memory in which a 2-transistor (2T) or 3-transistor (3T) gain cell is used as a memory cell and the transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells by utilizing characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers, and thus, a semiconductor device in which the NOSRAM is used for a large-scale cache memory, a large-scale main memory, or a large-scale storage memory can have higher performance.

The DOSRAM is an abbreviation for “dynamic oxide semiconductor RAM” and refers to a RAM including a one-transistor (1T) and one-capacitor (IC) memory cell. The DOSRAM is a DRAM formed using an OS transistor and temporarily stores information sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. For example, indium oxide (InOₓ) or indium gallium zinc oxide (In—Ga—Zn oxide, also referred to as “IGZO”) can be used for the channel formation region. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (S1), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium is. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide and gallium tin oxide).

### <<Processing Unit 23>>

The processing unit 23 has a function of performing processing such as arithmetic operation, analysis, and inference with use of data supplied from one or both of the input unit 21 and the storage unit 22. The processing unit 23 can supply generated data (e.g., an arithmetic operation result, an analysis result, or an inference result) to one or both of the storage unit 22 and the output unit 24.

The processing unit 23 has a function of obtaining data from the storage unit 22. The processing unit 23 can also have a function of storing or registering data in the storage unit 22.

The processing unit 23 can include an arithmetic circuit, for example. The processing unit 23 can include, for example, a central processing unit (CPU). The processing unit 23 can also include a graphics processing unit (GPU). Furthermore, the processing unit 23 can include a neural processing unit/neural network processing unit (NPU).

The processing unit 23 can include a microprocessor such as a digital signal processor (DSP). The microprocessor can be achieved with a programmable logic device (PLD) such as a field programmable gate array (FPGA) or a field programmable analog array (FPAA). The processing unit 23 can also include a quantum processor. The processing unit 23 can interpret and execute instructions from various programs with use of a processor to process various kinds of data and control programs. The programs to be executed by the processor are stored in at least one of the storage unit 22 and a memory region of the processor.

The processing unit 23 can include a main memory. The main memory includes at least one of a volatile memory such as RAM and a nonvolatile memory such as a read only memory (ROM). The main memory can include at least one of the above-described NOSRAM and DOSRAM.

Examples of the RAM include a DRAM and an SRAM; a virtual memory space is assigned and utilized as a working space of the processing unit 23. An operating system, an application program, a program module, program data, a look-up table, and the like which are stored in the storage unit 22 are loaded into the RAM for execution. The data, program, and program module which are loaded into the RAM are each directly accessed and operated by the processing unit 23.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 23 can include one or both of an OS transistor and a transistor including silicon in its channel formation region (S1 transistor).

The processing unit 23 preferably includes an OS transistor. Since the OS transistor has an extremely low off-state current, a long data retention period can be ensured with use of the OS transistor as a switch for retaining electric charge (data) that has flowed into a capacitor functioning as a memory element. When this feature is imparted to at least one of a register and a cache memory included in the processing unit, the processing unit can be operated only when needed, and otherwise can be off while information processed immediately before turning off the processing unit is stored in the memory element. In other words, normally-off computing is possible and the power consumption of the data processing system can be reduced.

The data processing device preferably uses AI for at least part of its processing.

In particular, the data processing device preferably uses an artificial neural network (ANN, hereinafter also simply referred to as a neural network). The neural network can be constructed with circuits (hardware) or programs (software).

In this specification and the like, the neural network indicates a general model having the capability of solving problems, which is modeled on a biological neural network and determines the connection strength of neurons by learning. The neural network includes an input layer, a middle layer (hidden layer), and an output layer.

In the description of the neural network in this specification and the like, determining a connection strength of neurons (also referred to as weight coefficients) from the existing information is referred to as “learning” in some cases.

In this specification and the like, drawing a new conclusion from a neural network formed with the connection strength obtained by learning is referred to as “inference” in some cases.

### <<Output Unit 24>>

The output unit 24 can output at least one of an arithmetic operation result, an analysis result, and an inference result in the processing unit 23 to the outside of the data processing device. For example, the output unit 24 can transmit data via the network 51. Specifically, a device such as a personal computer having a communication port or a communication function can be used. Furthermore, a device having a communication function may be used as the input unit 21 and the output unit 24.

### <<Transmission Path 25>>

The transmission path 25 has a function of transmitting data. Data transmission and reception between the input unit 21, the storage unit 22, the processing unit 23, and the output unit 24 can be performed via the transmission path 25. Specifically, an external bus, a LAN or the Internet can be used for the transmission path 25.

Note that this embodiment can be combined with any of the other embodiments in this specification as appropriate.

### Embodiment 2

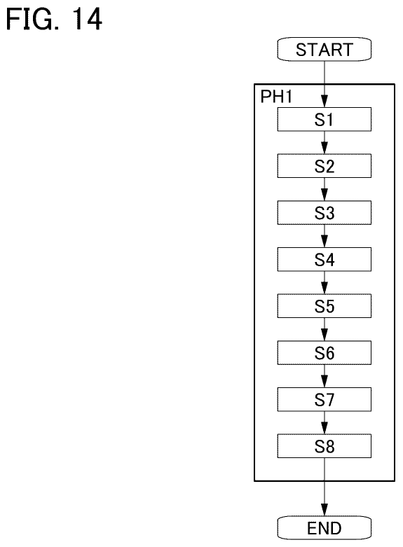

In this embodiment, a data processing method of one embodiment of the present invention will be described with reference to FIG. 14 to FIG. 19.

FIG. 14 is a flow diagram showing a data processing method of one embodiment of the present invention.

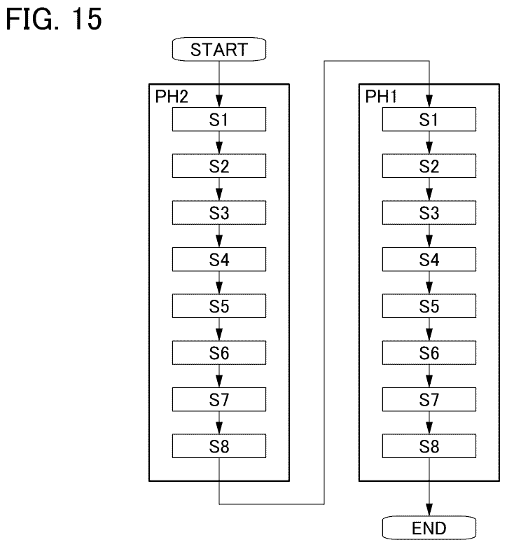

FIG. 15 is a flow diagram showing a data processing method of one embodiment of the present invention.

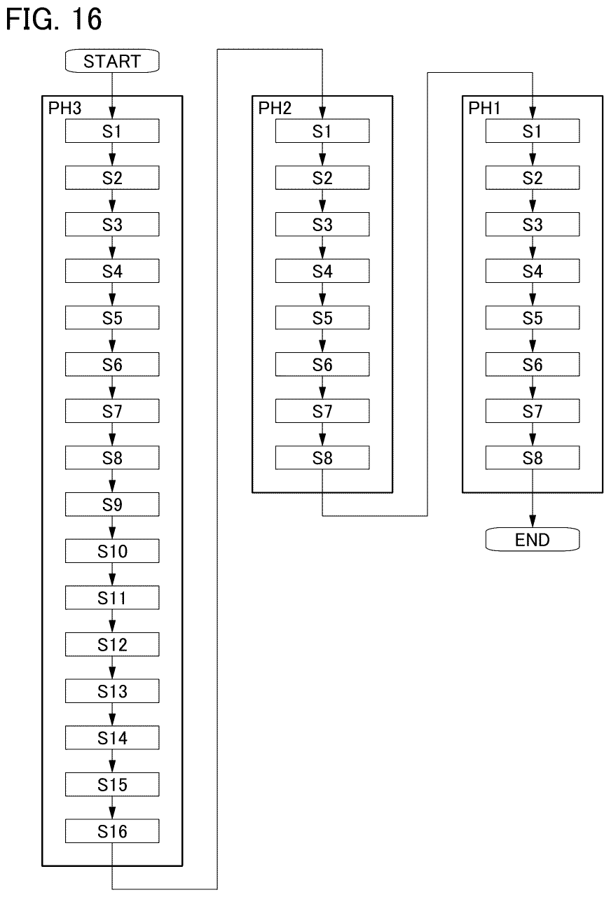

FIG. 16 is a flowing diagram showing a data processing method of one embodiment of the present invention.

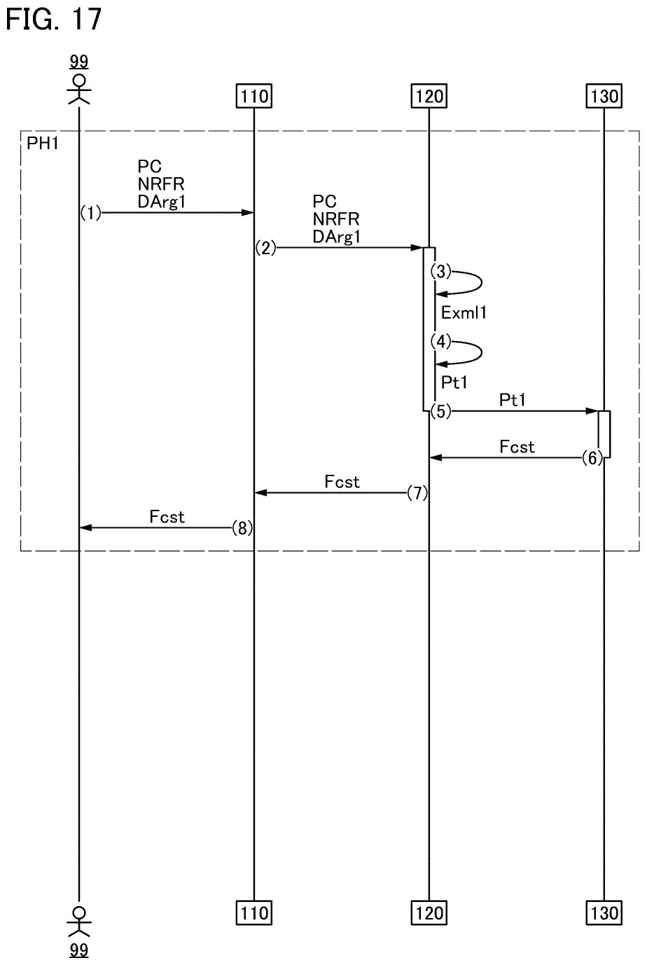

FIG. 17 is a sequence diagram showing a data processing method of one embodiment of the present invention.

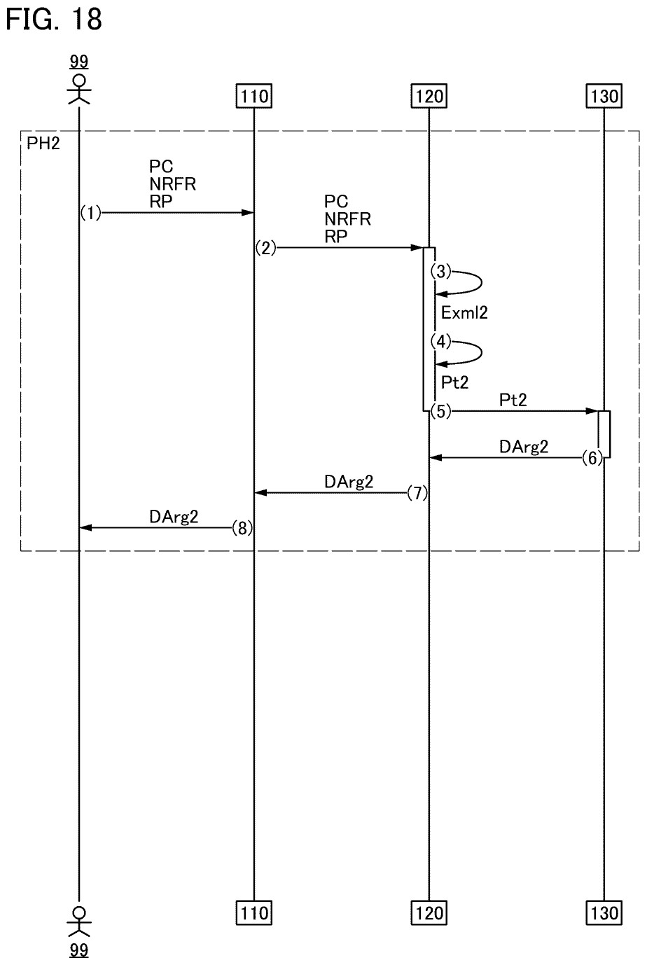

FIG. 18 is a sequence diagram showing a data processing method of one embodiment of the present invention.

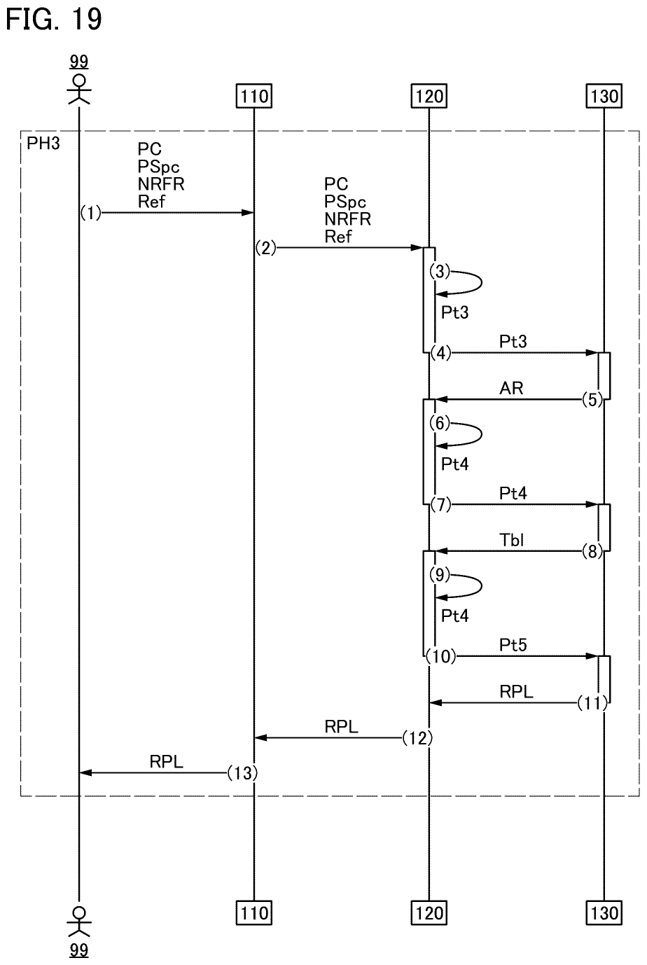

FIG. 19 is a sequence diagram showing a data processing method of one embodiment of the present invention.

### <Example 1 of Data Processing Method>

The data processing method of one embodiment of the present invention includes Phase PH1 (see FIG. 14).

### <Example of Phase PH1>

Phase PH1 includes Step S1 to Step S8.

### <<Step S1>>

In Step S1 of Phase PH1, the component 110 receives the scope of claims PC, the notice of reasons for refusal NRFR relating to the scope of claims PC, and the argument draft DArg1 relating to the notice of reasons for refusal NRFR and transmit them to the component 120. For example, a user of a data processing system inputs the scope of claims PC, the notice of reasons for refusal NRFR, and the argument draft DArg1. Step S1 corresponds to an arrow extending from (1) in FIG. 17 and an arrow extending from (2) therein.

### <<Step S2>>

In Step S2 of Phase PH1, the component 120 receives the scope of claims PC, the notice of reasons for refusal NRFR, and the argument draft DArg1 and shares them in the component 120. The component 120 includes the subcomponent 120A and the subcomponent 120B.

### <<Step S3>>

In Step S3 of Phase PH1, the subcomponent 120A extracts the examination record list ExmL1 from the database DB in accordance with the query Que1.

The query Que1 requires that the technical field match the scope of claims PC and requires that the examiner match the person in charge of the notice of reasons for refusal NRFR. Step S3 corresponds to an arrow extending from (3) in FIG. 17.

The database DB includes one or more of the examination records RExm. The examination record RExm includes a field for storing the argument record RArg, a field for storing the notification record RNtc, and a field for storing the information IDExm specifying an examiner in charge, and a field for storing the information TchF specifying a technical field. The notification record RNtc includes a decision on the argument record RArg.

### <<Step S4>>

In Step S4 of Phase PH1, the subcomponent 120B creates the prompt Pt1 and transmit it to the component 130.

The prompt Pt1 includes the instruction g1( ), the examination record list ExmL1, the notice of reasons for refusal NRFR, and the argument draft DArg1. The instruction g1( ) includes a procedure for generating the forecast Fcst with reference to the examination record list ExmL1. Step S4 corresponds to an arrow extending from (4) in FIG. 17 and an arrow extending from (5) therein.

### <<Step S5>>

In Step S5 of Phase PH1, the component 130 receives the prompt Pt1 and generates the forecast Fcst with use of the large language model LLM.

### <<Step S6>>

In Step S6 of Phase PH1, the component 130 transmits the forecast Fcst to the component 120. Step S6 corresponds to an arrow extending from (6) in FIG. 17.

### <<Step S7>>

In Step S7 of Phase PH1, the component 120 receives the forecast Fcst and transmits the forecast Fcst to the component 110. Step S7 corresponds to an arrow extending from (7) in FIG. 17.

### <<Step S8>>

In Step S8 of Phase PH1, the component 110 receives the forecast Fcst and provides it to the user of the data processing system, for example. Step S8 corresponds to an arrow extending from (8) in FIG. 17.

Accordingly, the decision on the argument draft DArg1 by the examiner in charge of the notice of reasons for refusal NRFR can be forecasted. Furthermore, the decision can be forecasted with reference to the examination record list ExmL1 of the examiner in charge of the notice of reasons for refusal NRFR. Furthermore, the decision can be forecasted from the argument record RArg and the notification record RNtc stored in the examination record list ExmL1. Moreover, the user of the data processing system can reconsider the argument draft DArg1 with reference to the forecast Fcst. Moreover, the user of the data processing system can review the response policy RP with reference to the forecast Fcst. As a result, a novel data processing method that is highly convenient, useful, or reliable can be provided.

### <Example 2 of Data Processing Method>

The data processing method of one embodiment of the present invention is a data processing method including Phase PH1 and Phase PH2 (see FIG. 15).

### <Example of Phase PH2>

Phase PH1 follows Phase PH2, and Phase PH2 includes Step S1 to Step S8.

### <<Step S1>>

In Step S1 of Phase PH2, the component 110 receives the response policy RP, the scope of claims PC, and the notice of reasons for refusal NRFR and transmits them to the component 120. For example, the user of the data processing system inputs the response policy RP. Step S1 corresponds to an arrow extending from (1) in FIG. 18 and an arrow extending from (2) therein.

### <<Step S2>>

In Step S2 of Phase PH2, the component 120 receives the response policy RP, the scope of claims PC, and the notice of reasons for refusal NRFR and shares them in the component 120.

### <<Step S3>>

In Step S3 of Phase PH2, the subcomponent 120A extracts the examination record list ExmL2 from the database DB in accordance with the query Que2.

The query Que2 requires that the technical field match the scope of claims PC, requires that the examiner match the notice of reasons for refusal NRFR, and requires that the argument record RArg is equivalent to the response policy RP. Step S3 corresponds to an arrow extending from (3) in FIG. 18.

### <<Step S4>>

In Step S4 of Phase PH2, the subcomponent 120B creates the prompt Pt2 and transmits it to the component 130.

The prompt Pt2 includes the instruction g2( ) and the examination record list ExmL2. The instruction g2( ) includes a procedure for generating the argument draft DArg2 with reference to the examination record list ExmL2. Step S4 corresponds to an arrow extending from (4) in FIG. 18 and an arrow extending from (5) therein.

### <<Step S5>>

In Step S5 of Phase PH2, the component 130 receives the prompt Pt2 and generates the argument draft DArg2 with use of the large language model LLM.

### <<Step S6>>

In Step S6 of Phase PH2, the component 130 transmits the argument draft DArg2 to the component 120. Step S6 corresponds to an arrow extending from (6) in FIG. 18.

### <<Step S7>>

In Step S7 of Phase PH2, the component 120 receives the argument draft DArg2 and transmits the argument draft DArg2 to the component 110. Step S7 corresponds to an arrow extending from (7) in FIG. 18.

### <<Step S8>>

In Step S8 of Phase PH2, the component 110 receives the argument draft DArg2 and provide it to the user of the data processing system, for example. Step S8 corresponds to an arrow extending from (8) in FIG. 18.

Accordingly, the argument draft DArg2 can be generated on the basis of the response policy RP. Furthermore, the argument draft DArg2 overturning a decision on the argument draft DArg1 can be generated, for example. In addition, the argument draft DArg2 which the examiner in charge of the notice of reasons for refusal NRFR is likely to accept can be generated, for example. As a result, a novel data processing method that is highly convenient, useful, or reliable can be provided.

### <Example 3 of Data Processing Method>

The data processing method of one embodiment of the present invention is a data processing method including Phase PH1, Phase PH2, and Phase PH3 (see FIG. 16).

### <Example of Phase PH3>

Phase PH2 follows Phase PH3, and Phase PH3 includes Step S1 to Step S16.

### <<Step S1>>

In Step S1 of Phase PH3, the component 110 receives the scope of claims PC, the specification PSpc relating to the scope of claims PC, the notice of reasons for refusal NRFR relating to the scope of claims PC, and the cited reference Ref relating to the notice of reasons for refusal NRFR and transmits them to the component 120. For example, the user of the data processing system inputs the scope of claims PC, the specification PSpc, the notice of reasons for refusal NRFR, and the cited reference Ref. Step S1 corresponds to an arrow extending from (1) in FIG. 19 and an arrow extending from (2) therein.

### <<Step S2>>

In Step S2 of Phase PH3, the component 120 receives the scope of claims PC, the specification PSpc, the notice of reasons for refusal NRFR, and the cited reference Ref and share them in the component 120.

### <<Step S3>>

In Step S3 of Phase PH3, the subcomponent 120B creates the prompt Pt3 and transmits it to the component 130.

The prompt Pt3 includes the instruction g3( ), the specification PSpc, the scope of claims PC, the notice of reasons for refusal NRFR, and the cited reference Ref. The instruction g3( ) includes a procedure for analyzing the notice of reasons for refusal NRFR with use of the specification PSpc, the scope of claims PC, and the cited reference Ref to generate the analysis result AR. Step S3 corresponds to an arrow extending from (3) in FIG. 19 and an arrow extending from (4) therein.

### <<Step S4>>

In Step 4 of Phase PH3, the component 130 receives the prompt Pt3 and generates the analysis result AR with use of the large language model LLM.

### <<Step S5>>

In Step S5 of Phase PH3, the component 130 transmits the analysis result AR to the component 120. Step S5 corresponds to an arrow extending from (5) in FIG. 19.

### <<Step S6>>

In Step S6 of Phase PH3, the component 120 receives the analysis result AR and shares it in the component 120.

### <<Step S7>>

In Step S7 of Phase PH3, the subcomponent 120B creates the prompt Pt4 and transmits it to the component 130.

The prompt Pt4 includes the instruction g4( ) and the analysis result AR. The instruction g4( ) includes a procedure for generating the correspondence table Tb1 from the analysis result AR. The correspondence table Tb1 includes the claim CL and the reason for refusal RFR relating to the claim CL. The claim CL is included in the scope of claims PC, and the reason for refusal RFR is included in the notice of reasons for refusal NRFR. Step S7 corresponds to an arrow extending from (6) in FIG. 19 and an arrow extending from (7) therein.

### <<Step S8>>

In Step S8 of Phase PH3, the component 130 receives the prompt Pt4 and generates the correspondence table Tb1 with use of the large language model LLM.

### <<Step S9>>

In Step S9 of Phase PH3, the component 130 transmits the correspondence table Tb1 to the component 120. Step S9 corresponds to an arrow extending from (8) in FIG. 19.

### <<Step S10>>

In Step S10 of Phase PH3, the component 120 receives the correspondence table Tb1 and shares it in the component 120.

### <<Step S11>>

In Step S11 of Phase PH3, the subcomponent 120B creates the prompt Pt5 and transmits it to the component 130.

The prompt Pt5 includes the instruction g5( ), the analysis result AR, and the correspondence table Tb1. The instruction g5( ) includes a procedure for generating the response policy list RPL. For each reason for refusal RFR in the response policy list RPL, a plurality of the response policies RP are listed. In addition, to each response policy RP, an advantage and a disadvantage are given. Step S11 corresponds to an arrow extending from (9) in FIG. 19 and an arrow extending from (10) therein.

### <<Step S12>>

In Step S12 of Phase PH3, the component 130 receives the prompt Pt5 and generates the response policy list RPL with use of the large language model LLM.

### <<Step S13>>

In Step S13 of Phase PH3, the component 130 transmits the response policy list RPL to the component 120. Step S13 corresponds to an arrow extending from (11) in FIG. 19.

### <<Step S14>>

In Step S14 of Phase PH1, the component 120 receives the response policy list RPL and transmits the response policy list RPL to the component 110. Step S14 corresponds to an arrow extending from (12) in FIG. 19.

### <<Step S15>>

In Step S15 of Phase PH1, the component 110 receives the response policy list RPL and provides it to the user of the data processing system, for example. Step S15 corresponds to an arrow extending from (13) in FIG. 19.

### <<Step S14>>

In Step S16 of Phase PH1, the component 110 stands by for an input of the response policy RP. For example, the user of the data processing system inputs the response policy RP.

Accordingly, the notice of reasons for refusal NRFR can be analyzed with use of the scope of claims PC, the specification PSpc, and the cited reference Ref to generate the analysis result AR. Furthermore, the correspondence table Tb1 where the claim CL and the reason for refusal RFR are linked can be generated from the analysis result AR. Furthermore, the response policy list RPL where a plurality of response policies RP are listed can be generated from the analysis result AR and the correspondence table Tb1 and provided. For example, to each response policy RP, an advantage and a disadvantage can be given. For example, the user of the data processing system can select the response policy RP with reference to the response policy list RPL. As a result, a novel data processing method that is highly convenient, useful, or reliable can be provided.

Note that this embodiment can be combined with any of the other embodiments in this specification as appropriate.

This application is based on Japanese Patent Application Serial No. 2024-119413 filed with Japan Patent Office on Jul. 25, 2024, the entire contents of which are hereby incorporated by reference.

What is claimed is:

1. A data processing system comprising:
a first component;
a second component; and
a third component comprising a first subcomponent and a second subcomponent,
wherein each of the first component and the third component is configured to receive a scope of claims, a notice of reasons for refusal relating to the scope of claims, a first argument draft relating to the notice of reasons for refusal, and a forecast,
wherein the second component is configured to perform processing using a large language model,
wherein the large language model is configured to generate the forecast in accordance with a first prompt generated by the second subcomponent,
wherein the second component is configured to transmit the forecast to the third component,
wherein the first subcomponent is configured to perform processing using a database comprising at least one examination record and a search engine,
wherein the examination record comprises information on at least one of an argument record, a notification record, an examiner in charge, and a technical field,
wherein the notification record comprises a decision on the argument record,
wherein the search engine is configured to extract a first examination record list from the database in accordance with a first query,
wherein the first prompt comprises a first instruction, the first examination record list, and the first argument draft,
wherein the first instruction comprises a procedure for generating the forecast with reference to the first examination record list, and
wherein the forecast comprises a decision on the first argument draft.

2. The data processing system according to claim 1,
wherein each of the first component and the third component is configured to receive a response policy,
wherein the second component is configured to receive a second prompt generated by the second subcomponent and to transmit a second argument draft generated using the large language model in accordance with the second prompt to the third component,
wherein the third component is configured to transmit the second argument draft to the first component,
wherein the search engine is configured to extract a second examination record list from the database in accordance with a second query,
wherein the second prompt comprises a second instruction and the second examination record list, and
wherein the second instruction comprises a procedure for generating the second argument draft with reference to the second examination record list.

3. The data processing system according to claim 2,
wherein the first query requires that the technical field match the scope of claims and requires that the examiner match a person in charge of the notice of reasons for refusal, and
wherein the second query requires that the technical field match the scope of claims, requires that the examiner match the person in charge of the notice of reasons for refusal, and requires that the argument record be equivalent to the response policy.

4. The data processing system according to claim 3,
wherein each of the first component and the third component is configured to receive a specification relating to the scope of claims, a reference cited in the notice of reasons for refusal, and a response policy list,
wherein the second component is configured to receive a third prompt, a fourth prompt, and a fifth prompt and to transmit an analysis result generated by the large language model in accordance with the third prompt, a correspondence table generated by the large language model in accordance with the fourth prompt, and the response policy list generated by the large language model in accordance with the fifth prompt to the third component, and
wherein the second subcomponent is configured to create the third prompt, the fourth prompt, and the fifth prompt and to transmit the third prompt, the fourth prompt, and the fifth prompt to the second component.

5. The data processing system according to claim 4,
wherein the third prompt comprises a third instruction, the specification, the scope of claims, the notice of reasons for refusal, and the cited reference,
wherein the third instruction comprises a procedure for analyzing the notice of reasons for refusal using the specification, the scope of claims, and the cited reference to generate the analysis result,
wherein the fourth prompt comprises a fourth instruction and the analysis result,
wherein the fourth instruction comprises a procedure for generating the corresponding table from the analysis result, and
wherein the correspondence table comprises at least one claim and at least one reason for refusal relating to the claim.

6. The data processing system according to claim 5,
wherein the claim is in the scope of claims,
wherein the reason for refusal is in the notice of reasons for refusal,
wherein the fifth prompt comprises a fifth instruction, the analysis result, and the correspondence table,
wherein the fifth instruction comprises a procedure for generating the response policy list,
wherein a plurality of response policies for the one reason for refusal are listed in the response policy list, and
wherein each of the plurality of response policies is provided with an advantage and a disadvantage.

7. A data processing method comprising:
a first phase,
wherein the first phase comprises a first step, a second step, a third step, a fourth step, a fifth step, a sixth step, a seventh step, and an eighth step,
wherein in the first step of the first phase, a first component receives a scope of claims, a notice of reasons for refusal relating to the scope of claims, and a first argument draft relating to the notice of reasons for refusal and transmits the scope of claims, the notice of reasons for refusal, and the first argument draft to a second component,
wherein in the second step of the first phase, the second component receives the scope of claims, the notice of reasons for refusal, and the first argument draft and shares the scope of claims, the notice of reasons for refusal, and the first argument draft in the second component,
wherein the second component comprises a first subcomponent and a second subcomponent,
wherein in the third step of the first phase, the first subcomponent extracts a first examination record list from a database in accordance with a first query,
wherein the first query requires that a technical field match the scope of claims and requires that an examiner match a person in charge of the notice of reasons for refusal,
wherein the data base comprises at least one examination record,
wherein the examination record comprises information on an argument record, a notification record, an examiner in charge, and a technical field,
wherein the notification record comprises a decision on the argument record,
wherein in the fourth step of the first phase, the second subcomponent creates a first prompt and transmits the first prompt to a third component,
wherein the first prompt comprises a first instruction, the first examination record list, and the first argument draft,
wherein the first instruction comprises a procedure for generating a forecast with reference to the first examination record list,
wherein in the fifth step of the first phase, the third component receives the first prompt and generates the forecast with use of a large language model,
wherein in the sixth step of the first phase, the third component transmits the forecast to the second component,
wherein in the seventh step of the first phase, the second component receives the forecast and transmits the forecast to the first component, and
wherein in the eighth step of the first phase, the first component receives the forecast and provides the forecast.

8. The data processing method according to claim 7, further comprising a second phase,
wherein the second phase follows the first phase,
wherein the second phase comprises a first step, a second step, a third step, a fourth step, a fifth step, a sixth step, a seventh step, and an eighth step,
wherein in the first step of the second phase, the first component receives the response policy, the scope of claims, and the notice of reasons for refusal and transmits the response policy, the scope of claims, and the notice of reasons for refusal to the second component,
wherein in the second step of the second phase, the second component receives the response policy, the scope of claims, and the notice of reasons for refusal and shares the response policy, the scope of claims, and the notice of reasons for refusal in the second component,
wherein in the third step of the second phase, the first subcomponent extracts a second examination record list from the database in accordance with a second query,
wherein the second query requires that the technical field match the scope of claims, requires that the examiner match the person in charge of the notice of reasons for refusal, and requires that the argument record be equivalent to the response policy,
wherein in the fourth step of the second phase, the second subcomponent creates a second prompt and transmits the second prompt to the third component,
wherein the second prompt comprises a second instruction and the second examination record list,
wherein the second instruction comprises a procedure for generating a second argument draft with reference to the second examination record list,
wherein in the fifth step of the second phase, the third component receives the second prompt and generates the second argument draft with use of the large language model,
wherein in the sixth step of the second phase, the third component transmits the second argument draft to the second component,
wherein in the seventh step of the second phase, the second component receives the second argument draft and transmits the second argument draft to the first component, and
wherein in the eighth step of the second phase, the first component receives the second argument draft and provides the second argument draft.

9. The data processing method according to claim 8, further comprising a third phase,
wherein the third phase follows the second phase,
wherein the third phase comprises a first step, a second step, a third step, a fourth step, a fifth step, a sixth step, a seventh step, an eighth step, a ninth step, a tenth step, an eleventh step, a twelfth step, a thirteenth step, a fourteenth step, a fifteenth step, and a sixteenth step,
wherein in the first step of the third phase, the first component receives the scope of claims, the specification relating to the scope of claims, the notice of reasons for refusal relating to the scope of claims, and a reference cited in the notice of reasons for refusal, and transmits the scope of claims, the specification, the notice of reasons for refusal, and the cited reference to the second component,
wherein in the second step of the third phase, the second component receives the scope of claims, the specification, the notice of reasons for refusal, and the cited reference and shares the scope of claims, the specification, the notice of reasons for refusal, and the cited reference in the second component,
wherein in the third step of the third phase, the second subcomponent creates a third prompt and transmits the third prompt to the third component,
wherein the third prompt comprises a third instruction, the specification, the scope of claims, the notice of reasons for refusal, and the cited reference,
wherein the third instruction comprises a procedure for analyzing the notice of reasons for refusal with use of the specification, the scope of claims, and the cited reference to generate an analysis result,
wherein in the fourth step of the third phase, the third component receives the third prompt and generates the analysis result with use of a large language model,
wherein in the fifth step of the third phase, the third component transmits the analysis result to the second component,
wherein in the sixth step of the third phase, the second component receives the analysis result and shares the analysis result in the second component,
wherein in the seventh step of the third phase, the second subcomponent creates a fourth prompt and transmits the fourth prompt to the third component,
wherein the fourth prompt comprises a fourth instruction and the analysis result,
wherein the fourth instruction comprises a procedure for generating a correspondence table from the analysis result,
wherein the correspondence table comprises at least one claim and at least one reason for refusal relating to the claim,
wherein the claim is in the scope of claims,
wherein the reason for refusal is in the notice of reasons for refusal,
wherein in the eighth step of the third phase, the third component receives the fourth prompt and generates the correspondence table using the large language model,
wherein in the ninth step of the third phase, the third component transmits the correspondence table to the second component,
wherein in the tenth step of the third phase, the second component receives the correspondence table and shares the correspondence table in the second component,
wherein in the eleventh step of the third phase, the second subcomponent creates a fifth prompt and transmits the fifth prompt to the third component,
wherein the fifth prompt comprises a fifth instruction, the analysis result, and the correspondence table,
wherein the fifth instruction comprises a procedure for generating a response policy list,
wherein a plurality of response policies for the one reason for refusal are listed in the response policy list,
wherein each of the plurality of response policies is provided with an advantage and a disadvantage,
wherein in the twelfth step of the third phase, the third component receives the fifth prompt and generates the response policy list with use of the large language model,
wherein in the thirteenth step of the third phase, the third component transmits the response policy list to the second component,
wherein in the fourteenth step of the third phase, the second component receives the response policy list and transmits the response policy list to the first component,
wherein in the fifteenth step of the third phase, the first component receives the response policy list and provides the response policy list, and
wherein in the sixteenth step of the third phase, the first component stands by for an input of the response policy.
